(19) United States
(12) Patent Application Publication
(10) Pub. No.: US 2011/0190135 A1
(43) Pub. Date: Aug. 4, 2011

(54) SYNERGISTIC HERBICIDAL COMPOSITION CONTAINING PENOXSULAM AND BUTACHLOR

(75) Inventors: Richard K. Mann, Franklin, IN (US); Yi-hsiou Huang, Pingtung Hsieng (TW)

(73) Assignee: DOW AGROSCIENCES LLC

(21) Appl. No.: 13/018,583

(22) Filed: Feb. 1, 2011

Related U.S. Application Data
(60) Provisional application No. 61/301,012, filed on Feb. 3, 2010.

(51) Int. Cl. A01N 43/54; A01P 13/00

(52) U.S. Cl. 504/136

(57) ABSTRACT

An herbicidal composition containing (a) penoxsulam and (b) butachlor provides synergistic control of selected weeds.

### CROSS REFERENCE TO RELATED APPLICATIONS

This application claims the benefit of U.S. Provisional Application Ser. No. 61/301,012 filed on 3 Feb. 2010.

### BACKGROUND OF THE INVENTION

The protection of crops from weeds and other vegetation which inhibit crop growth is a constantly recurring problem in agriculture. To help combat this problem, researchers in the field of synthetic chemistry have produced an extensive variety of chemicals and chemical formulations effective in the control of such unwanted growth. Chemical herbicides of many types have been disclosed in the literature and a large number are in commercial use.

In some cases, herbicidal active ingredients have been shown to be more effective in combination than when applied individually and this is referred to as “synergism.” As described in the Herbicide Handbook of the Weed Science Society of America, Eighth Edition, 2002, p. 462, “‘synergism’ [is] an interaction of two or more factors such that the effect when combined is greater than the predicted effect based on the response to each factor applied separately.” The present invention is based on the discovery that butachlor and penoxsulam, already known individually for their herbicidal efficacy, display a synergistic effect when applied in combination.

### SUMMARY OF THE INVENTION

The present invention concerns a synergistic herbicidal mixture comprising an herbicidally effective amount of (a) penoxsulam and (b) butachlor. The compositions may also contain an agriculturally acceptable adjuvant or carrier.

The present invention also concerns a method of controlling the growth of undesirable vegetation, particularly in rice, and the use of this synergistic composition.

### DETAILED DESCRIPTION OF THE INVENTION

Penoxsulam is the common name for (2-(2,2-difluoroethoxy)-N-(5,8-dimethoxy-[1,2,4]triazolo[1,5-c]pyrimidin-2-yl)-6-(trifluoromethyl)benzenesulfonamide. Its herbicidal activity is described in The Pesticide Manual, Fourteenth Edition, 2006. Penoxsulam controls barnyard grass, as well as many broad-leaved, sedge and aquatic weeds in rice.

Butachlor is the common name for N-butoxymethyl-2-chloro-2′,6′-diethylacetanilide. Its herbicidal activity is described in The Pesticide Manual, Fourteenth Edition, 2006. Butachlor controls annual grasses and certain broad-leaved weeds.

The term herbicide is used herein to mean an active ingredient that kills, controls or otherwise adversely modifies the growth of plants. An herbicidally effective or vegetation controlling amount is an amount of active ingredient which causes an adversely modifying effect and includes deviations from natural development, killing, regulation, desiccation, retardation, and the like. The terms plants and vegetation include germinant seeds, emerging seedlings and established vegetation.

Herbicidal activity is exhibited by the compounds of the synergistic mixture when they are applied directly to the plant or to the locus of the plant at any stage of growth or before planting or emergence. The effect observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, and the like, as well as the amount of chemical applied. These and other factors can be adjusted as is known in the art to promote non-selective or selective herbicidal action. Generally, it is preferred to apply the composition of the present invention from pre-emergence to relatively immature undesirable vegetation growth stages to achieve the maximum control of weeds.

In the composition of this invention, the active ingredient ratio (wt:wt) of butachlor to penoxsulam at which the herbicidal effect is synergistic lies within the range of between about 10:1 and about 300:1 with a ratio of about 20:1 to 100:1 being preferred, and 40:1 being most preferred.

The rate at which the synergistic composition is applied will depend upon the particular type of weed to be controlled, the degree of control required, and the timing and method of application. In general, the composition of the invention can be applied at an application rate of between about 153 grams active ingredient per hectare (gai/ha) and about 1850 gai/ha based on the total amount of active ingredients in the composition. An application rate between about 310 gai/ha and about 1250 gai/ha is preferred. In an especially preferred embodiment of the invention, butachlor is applied at a rate between about 400 gai/ha and about 1200 gai/ha, and penoxsulam is applied at a rate between about 10 gai/ha and about 50 gai/ha.

The components of the synergistic mixture of the present invention can be applied either separately or as part of a multipart herbicidal system.

The synergistic mixture of the present invention can be applied in conjunction with one or more other herbicides to control a wider variety of undesirable vegetation. When used in conjunction with other herbicides, the composition can be formulated with the other herbicide or herbicides, tank mixed with the other herbicide or herbicides or applied sequentially with the other herbicide or herbicides. Some of the herbicides that can be employed in conjunction with the synergistic composition of the present invention include: 2,4-D, acetochlor, acifluorfen, aclonifen, alachlor, amidosulfuron, aminocyclopyraclor, aminopyralid, aminotriazole, ammonium thiocyanate, anilifos, azimsulfuron, benfuresate, bensulfuron-methyl, bentazone, benthiocarb, benzobicyclon, benzofenap, bifenox, bispyribac-sodium, bromacil, bromobutide, bromoxynil, butafenacil, butralin, cafenstrole, carbetamide, carfentrazone-ethyl, chlorflurenol, chlorimuron, chlorpropham, cinosulfuron, clethodim, clodinafop-propargyl, clomazone, clomeprop, clopyralid, cloransulam-methyl, cumyluron, cyclosulfamuron, cycloxydim, cyhalofop-butyl, daimuron, dicamba, dichlobenil, dichlorprop-P, diclosulam, diflufenican, diflufenzopyr, dimepiperate, dimethametryn, dimethenamid, dimethenamid-p, diquat, dithiopyr, diuron, EK2612, EPTC, esprocarb, ethoxysulfuron, etobenzanid, fenoxaprop, fenoxaprop-ethyl, fenoxaprop-ethyl+isoxidifen-ethyl, fentrazamide, flazasulfuron, florasulam, fluazifop, fluazifop-P-butyl, flucetosulfuron, flufenacet, flufenpyr-Ethyl, flumetsulam, flumiclorac-pentyl, flumioxazin, fluometuron, flupyrsulfuron, fluoroxypyr, fomesafen, foramsulfuron, fumiclorac, glufosinate, glufosinate-ammonium, glufosinate-P, glyphosate, halosulfuron, haloxyfop-methyl, haloxyfop-R, imazamethabenz, imazamox, imazapic, imazapyr, imazaquin, imazethapyr, imazosulfuron, indanofan, iodosulfuron, ioxynil, ipfencarbazone, isoproturon, isoxaben, isoxaflutole, lactofen, MCPA, MCPB, mecoprop-P, mefenacet, mesosulfuron, mesotrione, metamifop, metolachlor, metosulam, metsulfuron, molinate, monosulfuron, MSMA, napropamide, nicosulfuron, norflurazon, OK-9701, orthosulfamuron, oryzalin, oxadiargyl, oxadiazon, oxazichlomefone, oxyfluorfen, paraquat, pendimethalin, pentoxazone, pethoxamid, picloram, picolinafen, piperophos, pretilachlor, primisulfuron, profoxydim, propachlor, propanil, propisochlor, propyzamide, prosulfocarb, prosulfuron, pyraclonil, pyraflufen-ethyl, pyrazogyl, pyrazolynate, pyrazosulfuron-ethyl, pyrazoxyfen, pyribenzoxim, pyrabuticarb, pyriftalid, pyriminobac-methyl, pyrimidsulfan, pyroxsulam, quinclorac, quinoclamine, quizalofop-ethyl-D, S-3252, saflufenacil, sethoxydim, simazine, simetryne, SL-0401, SL-0402, s-metolachlor, sulcotrione, sulfentrazone, sulfosate, tefuryltrione, tembotrione, terbacil, thenylchlor, thiazopyr, thiobencarb, triclopyr, trifluralin, trinexapac-ethyl and tritosulfuron.

The synergistic composition of the present invention can be used on acetolactate synthase inhibitor tolerant crops. The synergistic composition of the present invention can further be used in conjunction with 2,4-D, glyphosate, glufosinate, dicamba or imidazolinones on glyphosate-tolerant, glufosinate-tolerant, dicamba-tolerant or imidazolinone-tolerant crops.

It is generally preferred to use the synergistic composition of the present invention in combination with herbicides that are selective for the crop being treated and which complement the spectrum of weeds controlled by these compounds at the application rate employed. It is further generally preferred to apply the synergistic composition of the present invention and other complementary herbicides at the same time, either as a combination formulation or as a tank mix.

The synergistic composition of the present invention can generally be employed in combination with known herbicide safeners, such as benoxacor, benthiocarb, brassinolide, cloquintocet (mexyl), cyometrinil, cyprosulfamate, daimuron, dichlormid, dicyclonon, dietholate, dimepiperate, disulfoton, fenchlorazole-ethyl, fenclorim, flurazole, fluxofenim, furilazole, isoxadifen-ethyl, mefenpyr-diethyl, mephenate, MG 191, MON 4660, naphthalic anhydride (NA), oxabetrinil, 829148 and N-phenyl-sulfonylbenzoic acid amides, to enhance their selectivity.

In practice, it is preferable to use the synergistic composition of the present invention in mixtures containing an herbicidally effective amount of the herbicidal components along with at least one agriculturally acceptable adjuvant or carrier. Suitable adjuvants or carriers should not be phytotoxic to valuable crops, particularly at the concentrations employed in applying the compositions for selective weed control in the presence of crops, and should not react chemically with herbicidal components or other composition ingredients. Such mixtures can be designed for application directly to weeds or their locus or can be concentrates or formulations that are normally diluted with additional carriers and adjuvants before application. They can be solids, such as, for example, dusts, granules, water dispersible granules, or wettable powders, or liquids, such as, for example, emulsifiable concentrates, solutions, emulsions or suspensions.

Suitable agricultural adjuvants and carriers that are useful in preparing the herbicidal mixtures of the invention are well known to those skilled in the art. Some of these adjuvants include, but are not limited to, crop oil concentrate (mineral oil (85%)+emulsifiers (15%)); nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO); PEG(400) dioleate-99.

Liquid carriers that can be employed include water and organic solvents. The organic solvents typically used include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cotton seed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. Water is generally the carrier of choice for the dilution of concentrates.

Suitable solid carriers include talc, pyrophyllite clay, silica, attapulgus clay, kaolin clay, kieselguhr, chalk, diatomaceous earth, lime, calcium carbonate, bentonite clay, Fuller's earth, cotton seed hulls, wheat flour, soybean flour, pumice, wood flour, walnut shell flour, lignin, and the like.

It is usually desirable to incorporate one or more surface-active agents into the compositions of the present invention. Such surface-active agents are advantageously employed in both solid and liquid compositions, especially those designed to be diluted with carrier before application. The surface-active agents can be anionic, cationic or nonionic in character and can be employed as emulsifying agents, wetting agents, suspending agents, or for other purposes. Surfactants conventionally used in the art of formulation and which may also be used in the present formulations are described, inter alia, in “McCutcheon's Detergents and Emulsifiers Annual,” MC Publishing Corp., Ridgewood, N.J., 1998 and in “Encyclopedia of Surfactants,” Vol. I-III, Chemical Publishing Co., New York, 1980-81. Typical surface-active agents include salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutyl-naphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono- and dialkyl phosphate esters; vegetable oils such as soybean oil, rapeseed oil, olive oil, castor oil, sunflower seed oil, coconut oil, corn oil, cotton seed oil, linseed oil, palm oil, peanut oil, safflower oil, sesame oil, tung oil and the like; and esters of the above vegetable oils.

Other adjuvants commonly used in agricultural compositions include compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

The concentration of the active ingredients in the synergistic composition of the present invention is generally from 0.001 to 98 percent by weight. Concentrations from 0.01 to 90 percent by weight are often employed. In compositions designed to be employed as concentrates, the active ingredients are generally present in a concentration from 5 to 98 weight percent, preferably 10 to 90 weight percent. Such compositions are typically diluted with an inert carrier, such as water, before application. The diluted compositions usually applied to weeds or the locus of weeds generally contain 0.0001 to 1 weight percent active ingredient and preferably contain 0.001 to 0.05 weight percent.

The present compositions can be applied to weeds or their locus by the use of conventional ground or aerial dusters, sprayers, and granule applicators, by addition to irrigation water, and by other conventional means known to those skilled in the art.

The following examples illustrate the present invention.

### Examples

Evaluation of Preemergence Herbicidal Activity of Mixtures under Field Conditions

Methodology

Field trials were conducted in rice using standard herbicide small plot research methodology. Plot size was 2 m² using 1.6 m diameter rings placed into the paddy soil with capability for flooding with water to represent flooded rice culture. There were 3 replicates per treatment. Rice was Japonica type that was sown in rice nursery boxes as per normal cultural practices, and then transplanted 30 days after sowing into flooded rings. The rice crop was grown using normal cultural practices for fertilization, seeding, watering, flooding and maintenance to ensure good growth of the crop and the weeds under seeded rice conditions in Taiwan. Ring plot water depth was maintained at 3 to 7 cm depth after transplanting. Just prior to treatment application, plot water was drained to maintain saturated soil in ring plot. Treatments were applied by hand and water was re-induced to 3 to 7 cm depth 24 hours after application.

All treatments in the field trials were applied by mixing the treatments with soil just prior to application by hand into the ring plots at 5 to 7 days after transplanting. Commercially available products of penoxsulam and butachlor were mixed in water and sprayed onto 45 grams of soil, which is equivalent to the area treated at an application rate of 225 kg soil/ha. For each 2 m² plot, 45 g soil was mixed with the appropriate formulated product amounts to treat 2 m² to achieve the desired application rates based on unit area of application (hectare). Treatments were rated as compared to the untreated control plots. Visual weed control was rated on a scale of 0 to 100 percent, where 0 corresponds to no injury and 100 corresponds to complete kill.

Evaluation

The treated plots and control plots were rated blind at various intervals after application. Ratings were based of Percent (%) Visual weed control, where 0 corresponds to no injury and 100 corresponds to complete kill.

Data was collected for all trials and analyzed using various statistical methods.

Colby's equation was used to determine the herbicidal effects expected from the mixtures (Colby, S. R. Calculation of the synergistic and antagonistic response of herbicide combinations. Weeds 1967 15, 20-22).

The following equation was used to calculate the expected activity of mixtures containing two active ingredients, A and B:

Expected=A+B−(A×B/100)

A=observed efficacy of active ingredient A at the same concentration as used in the mixture;

B=observed efficacy of active ingredient B at the same concentration as used in the mixture.

The results are summarized in Tables 1 through 3.

TABLE 1
Synergistic weed control of ECHCG following an application of
Penoxsulam + Butachlor to transplanted rice - Field trial #1.

| | | | |
|---|---|---|---|
| | | Days | |
| Penoxsulam | Butachlor | After | ECHCG |

| | | | |
|---|---|---|---|
| (rate in grams ai/ha) | Application | Obs | Expected* |

| | | | | |
|---|---|---|---|---|
| 30 | 0 | 42 | 27 | — |
| 0 | 600 | 42 | 0 | — |
| 30 | 600 | 42 | 90 | 27 |

TABLE 2
Synergistic weed control of ECHCG and MOOVA following
an application of Penoxsulam + Butachlor to
transplanted rice-Field trial #2.

| | | Days | | | | |
|---|---|---|---|---|---|---|
| | | After | | | | |
| Penoxsulam | Butachlor | Appli- | ECHCG | | MOOVA | |
| (rate in grams ai/ha) | | cation | Obs | Expected* | Obs | Expected* |
| 3.8 | 0 | 28 | 0 | — | 75 | — |
| 0 | 300 | 28 | 13 | — | 26 | — |
| 3.8 | 300 | 28 | 48 | 13 | 99 | 83 |
| 7.5 | 0 | 28 | 15 | — | — | — |
| 0 | 300 | 28 | 13 | — | — | — |
| 7.5 | 300 | 28 | 88 | 25 | — | — |
| 15 | 0 | 28 | 88 | — | — | — |
| 0 | 300 | 28 | 13 | — | — | — |
| 15 | 300 | 28 | 97 | 90 | — | — |

TABLE 3
Synergistic weed control of ISCRU following an application of
Penoxsulam + Butachlor to transplanted rice - Field trial #3.

| | | | |
|---|---|---|---|
| | | Days | |
| Penoxsulam | Butachlor | After | ISCRU |

| | | | |
|---|---|---|---|
| (rate in grams ai/ha) | Application | Obs | Expected* |

| | | | | |
|---|---|---|---|---|
| 13 | 0 | 42 | 1 | — |
| 0 | 300 | 42 | 23 | — |
| 13 | 300 | 42 | 52 | 24 |

ECHCG - barnyard grass (Ehinochloa crus-galli)
MOOVA - pickerel weed (Monochoria vaginalis)
ISCRU - winklegrass (Ischaemum rugosum)
grams ae/ha - grams of active ingredient per hectare
Obs - percent control observed
Expected* - percent control expected by Colby equation

What is claimed is:

1. A synergistic herbicidal mixture comprising an herbicidally effective amount of (a) penoxsulam and (b) butachlor.

2. The synergistic herbicidal mixture of claim 1 in which the weight ratio of butachlor to penoxsulam is between about 10:1 and about 300:1.

3. A herbicidal composition comprising an herbicidally effective amount of the synergistic herbicidal mixture of claim 1 and an agriculturally acceptable adjuvant or carrier.

4. A method of controlling undesirable vegetation which comprises contacting the vegetation or the locus thereof with an herbicidally effective amount the synergistic herbicidal mixture of claim 1.

5. A method of controlling undesirable vegetation in rice which comprises contacting the vegetation or the locus thereof with an herbicidally effective amount the synergistic herbicidal mixture of claim 1.

6. The method of claim 5 in which the herbicidally effective amount the synergistic herbicidal mixture is applied pre-emergently to the locus of the undesirable vegetation.
